(19) United States
(12) Patent Application Publication
(10) Pub. No.: US 2017/0325423 A1
(43) Pub. Date: Nov. 16, 2017

(54) ELIZABETHAN ANIMAL COLLAR

(71) Applicant: Ganco Products, Inc., St. Louis, MO (US)

(72) Inventor: Michael G. McGrath, Wildwood, MO (US)

(21) Appl. No.: 15/151,475

(22) Filed: May 10, 2016

(51) Int. Cl. A01K 13/00; A01K 15/04

(52) U.S. Cl. CPC A01K 13/006; A01K 15/04

(57) ABSTRACT

A veterinary Elizabethan Collar is provided that when unconstructed resembles a semi-circular shape. When the collar is constructed, it is in the shape of a truncated cone. The collar includes receivers on one side and tab mechanisms on the other side such that when the receivers are placed over receiving mechanisms to form a collar of a desired size, the receiver members can be selectively engaged with the tab mechanisms. The collar may also include collar stays that can be selectively attached to an animal's existing collar to help keep the Elizabethan collar in place.

### FIELD OF INVENTION

The present invention relates generally to veterinary care, and more particularly an Elizabethan Collar (“E-Collar”) for wear around the neck of an animal such as a dog or cat such that the animal does not scratch and/or bite at skin wounds, hot spots, or post-operative stitches.

### BACKGROUND OF INVENTION

E-Collars are protective medical devices worn by animals such as cats or dogs. E-Collars are traditionally shaped like a truncated cone and aim to prevent an animal from biting or licking at its body, or scratching at its head or neck while wounds or injuries are healing.

FIG. 1 illustrates an E-Collar that is known in the prior art. Prior Art E-Collar 1 includes an assembly strap 3, a first window 5, a second window 7, and a closing slot 9. E-Collar 1 also includes a first set of assembly receiver slots 11 and a second set of assembly receiver slots 13. Each set of assembly receiver slots 11, 13 includes a first pair of tightening slots 15 toward an interior of E-Collar 1 and a second pair of tightening slots 17 located near an exterior portion of E-Collar 1. E-Collar 1 generally includes a first left side 19 and a second right side 21.

In order to form E-Collar 1 in a manner that may be worn around the neck of an animal, left side 19 is first placed over right side 21 such that first window 5 aligns with either of the first pairs of tightening slots 15, and second window 7 aligns with either of the second pairs of tightening slots 17 in line with the desired receiver slots 11, 13 depending on the animal's neck size. Assembly strap 3 may then be inserted through first window 5 and a first tightening slot 23 of tightening slots 15. It is then looped back through a second tightening slot 25 of first pair of tightening slots 15 and out through first window 5.

Assembly strap 3 may then be inserted into second window 7 where it is pushed through a first tightening slot 27 of second set of tightening slots 17 and back through a second slot 29 of tightening slots 17. Assembly strap 3 is returned through second window 7 and out through closing slot 9 where it is secured, thus forming the collar shape known in the art.

Each E-Collar 1 also includes three collar straps 31. E-Collar 1 also includes a pair of collar slots 33 associated with each of collar straps 31. Each of collar slots 33 includes an inner slot 35 and an outer slot 37. Each collar strap 31 is pushed through inner slot 35 and pushed out outer slot 37 to form a loop that can be engaged with a dog collar as known and understood in the art to keep E-Collar 1 in its position when in use.

E-Collar 1 includes numerous operations involving assembly strap 3 and the plurality of collar straps 31 in order to secure the collar to a dog or other animal E-Collar 1 is overly complicated. The several steps involved in constructing E-Collar 1 can easily lead to E-Collar 1 being placed incorrectly on an animal's neck. If E-Collar 1 is incorrectly placed around an animal's neck, it may fall off such that it no longer performs its function of keeping an animal from licking, scratching or biting a wound. It also may rub an animal's skin in a manner that causes a wound to be worsened. E-Collar 1 is overly complicated and improper attachment stemming from its complicated design can lead to further health issues for an animal.

### SUMMARY OF THE INVENTION

The present invention relates to a veterinary E-Collar for wear around an animal's neck to prevent the animal from scratching and/or biting at skin wounds, hot spots, or post-operative stitches. The collar preferably includes a first side that has a first receiver and a second receiver. The collar also may include a second side that includes multiple tab mechanisms including a first tab mechanism and a second tab mechanism. The first tab mechanism is preferably selectively engageable with the first receiver, and the second tab mechanism is preferably selectively engageable with the second receiver. When the first receiver is engaged with the first tab mechanism, and the second receiver is engaged with the second tab mechanism, a collar may be formed that is in the shape of a truncated cone.

Each collar may include a plurality of tab mechanisms, wherein the first tab mechanism and second tab mechanism associated with each tab mechanism are in substantial alignment with one another such that they may be engaged with the receivers when the collar is formed as a truncated cone.

The collar may also include a plurality of collar stays that can be selectively attachable to an existing collar worn by an animal, such as a dog or cat.

In at least one embodiment, each tab mechanism, both of the first tab mechanism and the second tab mechanism include an inner finger and an outer finger which act as the mechanism for selectively engaging with the receiver and forming the truncated cone collar shape.

In yet another alternative embodiment the collar includes padding at both of its interior and exterior portions to increase the comfort level of an animal wearing the collar.

### DESCRIPTION OF THE DRAWINGS

For a better understanding of the various embodiments of the present invention, reference may be made to the accompanying drawings in which:

FIG. 1 is a top plan view of a prior art Elizabethan Collar;

FIG. 2 is a top plan view of an Elizabethan Collar constructed according to the teachings of the present invention;

FIG. 3 is a top plan view of an alternative embodiment of an Elizabethan Collar constructed according to the teachings of the present invention.

### DETAILED DESCRIPTION OF THE INVENTION

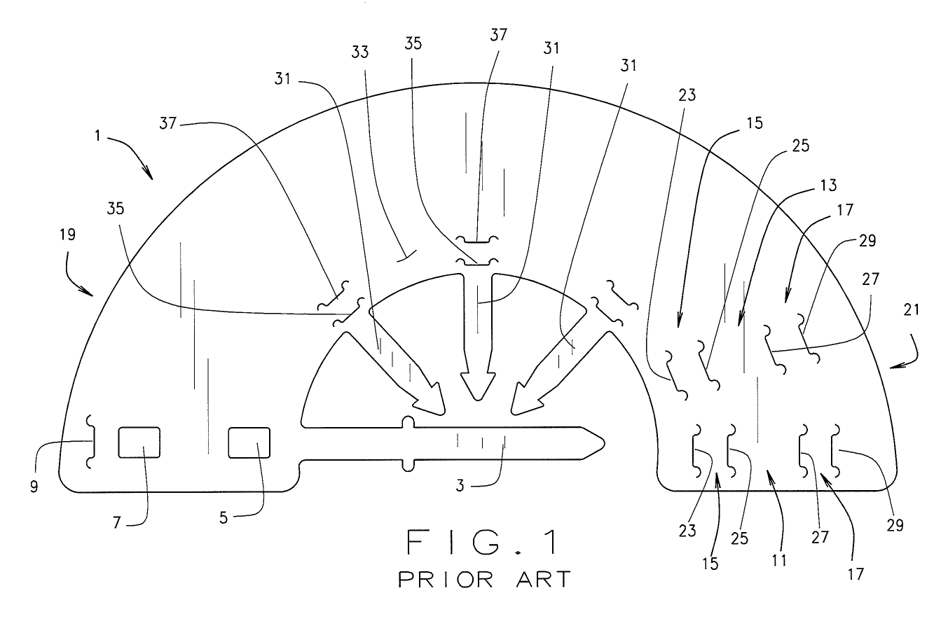

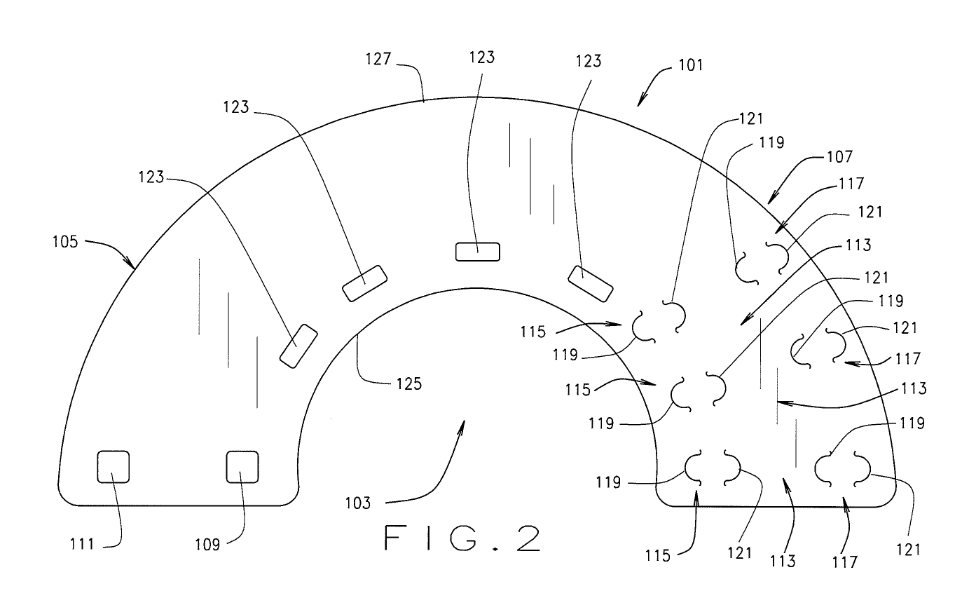

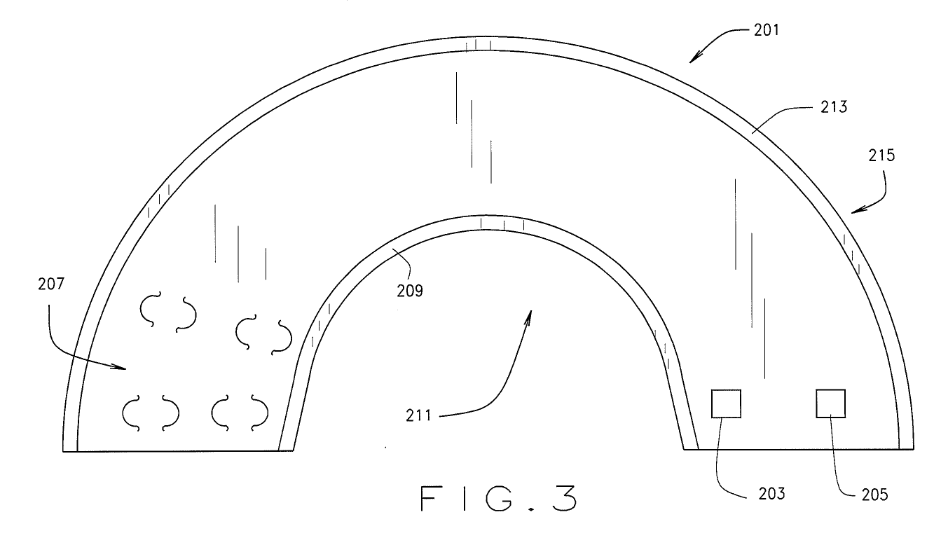

The E-Collars taught and disclosed in FIGS. 2 and 3 aim to improve upon prior art E-Collars such as those shown and described in FIG. 1. FIG. 2 illustrates a first E-Collar 101 that forms a half circle shape. Collar 101 includes an interior portion 103 that forms a hole through which an animal's head may be placed when collar 101 is constructed in the manner discussed herein below in greater detail. Collar 101 is preferably generally comprised of a first left portion 105 and a second right portion 107.

Left portion 105 preferably includes a first receiver member 109 and a second receiver member 111, wherein second receiver member 111 is outwardly positioned relative to first receiver member 109.

Collar 101 also preferably includes a plurality of tab mechanisms 113. FIG. 2 illustrates three tab mechanisms 113, however in alternative embodiments, collar 101 may include more or fewer tab mechanisms 113. Each tab mechanism 113 preferably includes a first tab 115 and a second tab 117. Preferably first tab 115 and first receiver member 109 are positioned and located such that they are in substantial alignment with one another when left portion 105 of collar 101 overlaps right portion 107 of collar 101. Similarly, second tab 117 and second receiver member 111 are preferably in substantial alignment with one another when left portion 105 of collar 101 overlaps right portion 107 of collar 101.

Each of tab mechanisms 113 may include an inner finger 119 and an outer finger 121. In the illustrated embodiment, fingers 119, 121 are semi-circular in shape, though in alternative embodiments, fingers 119, 121 may be different shapes.

To construct E-Collar 101, left portion 105 is preferably placed such that it overlaps right portion 107. Depending on the size of the animal's neck for which E-Collar 101 will be used, first receiver member 109 is preferably positioned in substantial alignment with any one of first tabs 115, and second receiver member 111 is preferably positioned in substantial alignment with a second tab 117 associated with the chosen first tab 115.

First tab 115 may be selectively engaged with first receiver member 109 by lifting first finger member 119 and placing it over an edge of first receiver member 109 and subsequently lifting second finger member 121 of first tab 115 and placing it over an opposite edge of first receiver member 109. Second tab 117 may be selectively engaged to second receiver member 111 in a substantially similar manner. In at least one embodiment, second tab 117 and second receiver member 111 may be selectively engaged prior to the selective engagement of first tab 115 and first receiver member 109. By engaging an appropriate tab 115 with first receiver member 109 and an appropriate corresponding second tab 117 with second receiver member 111, a conical shape familiar to known E-Collars is constructed. Using the aforementioned construction components and method eliminates the need for a cumbersome attachment strap such as attachment strap 3 shown and described for E-Collar 1 of the prior art.

E-Collar 101 may further include a plurality of collar stays 123 that may be selectively engageable with a dog or cat collar, either directly or in an interweaving fashion. Using collar stays 123 eliminates the need for collar straps such as collar straps 31 shown and illustrated in prior art E-Collar 1 of FIG. 1.

FIG. 3 illustrates an alternative E-Collar 201. E-Collar 301 is similar to E-Collar 101 illustrated in FIG. 2. E-Collar 201 preferably includes receivers 203 and 205 that are substantially similar to receivers 109, 111 of E-Collar 101. E-Collar 201 also may include tab mechanisms 207 that operate substantially similarly to tab mechanisms 113 of E-Collar 101. The means in which the various tab mechanisms 207 selectively are engaged with receivers 203, 205 are also preferably substantially similar to the selective engagement described for E-Collar 101. E-Collar 201 of FIG. 3 does not include collar stays similar to collar stays 123 of E-Collar 101, though in some embodiments it may. E-Collar 201 also preferably includes a padded layer 209 placed around its interior 211 such that when E-Collar 201 is constructed and worn by an animal, it is more comfortable. Similarly, padding 213 may be placed around an exterior 215 of E-Collar 201 to further add to the comfort of an animal wearing the device. E-Collar 101 of FIG. 2 may also include padding around its interior edge 125 and/or exterior edge 127, similar to padding 213 around exterior 215 and padding 209 around interior 211 of E-Collar 201 of FIG. 3. As shown in FIG. 3 compared to FIG. 2, an E-Collar such as E-Collar 101 or E-Collar 201 may include any number of tab mechanisms such as tab mechanisms 113 or 207 to allow for customized fit of an E-Collar.

From the foregoing, it will be seen that the various embodiments of the present invention are well adapted to attain all the objectives and advantages hereinabove set forth together with still other advantages which are obvious and which are inherent to the present structures. It will be understood that certain features and sub-combinations of the present embodiments are of utility and may be employed without reference to other features and sub-combinations. Since many possible embodiments of the present invention may be made without departing from the spirit and scope of the present invention, it is also to be understood that all disclosures herein set forth or illustrated in the accompanying drawings are to be interpreted as illustrative only and not limiting. The various constructions described above and illustrated in the drawings are presented by way of example only and are not intended to limit the concepts, principles and scope of the present invention.

Thus, there has been shown and described several embodiments of a novel shoe fastener strap. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. In addition, use of the terms “coupled to” or “coupled with” in the foregoing specification and subsequent claims is intended to mean that other members, components and/or mechanisms may lie between the two members that are “coupled together”, and direct attachments, connection or mating of the two members is not required. The same definition is likewise true when using the term “in fluid connection with” in the foregoing specification and subsequent claims. Two members, components or mechanisms “in fluid communication with” each other does require direct connection, attachment or mating between such members but does mean that other members, components and/or mechanisms may lie between such members.

Many changes, modifications, variations and other uses and applications of the present constructions will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. An E-Collar comprising:
a first side of the E-Collar including at least a first receiver;
a second side of the E-Collar including a plurality of at least first tab mechanisms; and
padding at an edge of the E-Collar;
wherein at least one of said first tab mechanisms is selectively engageable with the first receiver.

2. The E-Collar of claim 1, wherein the E-Collar also includes a plurality of collar stays which may be selectively attachable with a collar worn by an animal.

3. The E-Collar of claim 1, wherein each tab mechanism includes an inner finger and an outer finger which are selectively engageable with the receiver.

4. The E-Collar of claim 1, wherein the E-Collar further includes said padding at an interior edge of the E-Collar.

5. The E-Collar of claim 1, wherein the E-Collar further includes said padding at an exterior edge of the E-Collar.

6. The E-Collar of claim 1, wherein E-Collar includes a plurality of at least second tab mechanisms.
